(19) United States
(12) Patent Application Publication
(10) Pub. No.: US 2026/0095804 A1
(43) Pub. Date: Apr. 2, 2026

(54) METHOD AND DEVICE FOR DYNAMICALLY MODIFYING RADIO ACCESS NETWORK (RAN) CONFIGURATION

(71) Applicant: SAMSUNG ELECTRONICS CO., LTD., Suwon-si, Gyeonggi-do (KR)

(72) Inventors: Aneesh Narendra DESHMUKH, Bangalore (IN); Nayan OSTWAL, Bangalore (IN); Neha SHARMA, Bangalore (IN); Mahantesh KOTHIWALE, Bangalore (IN); Anshuman NIGAM, Bangalore (IN)

(21) Appl. No.: 19/110,505

(22) PCT Filed: Sep. 13, 2023
(86) PCT No.: PCT/KR2023/013738

§ 371 Date: Mar. 11, 2025

(30) Foreign Application Priority Data
Sep. 13, 2022 (IN) 202241052348
Aug. 28, 2023 (IN) 202241052348

(51) Int. Cl. H04W 28/02; H04W 28/16

(52) U.S. Cl. CPC H04W 28/0236; H04W 28/16

(57) ABSTRACT

Disclosed is a method and device for dynamically modifying radio access network (RAN) configuration at a user plane during a RAN layer processing. The method comprises determining a data packet loss ratio during a transmission of a plurality of data packets via a transmission channel. The method further comprises comparing the determined data packet loss ratio with a first threshold value to determine good channel conditions. Based on a result of comparison, the method comprises determining whether a current condition of the transmission channel is reliable or unreliable. Further, the method comprises incrementing a timestamp corresponding to a time at which the current condition of the transmission channel is determined as reliable. Subsequently, the method comprises dynamically modifying the RAN configuration at the user plane upon a determination that the incremented timestamp value is greater than the second threshold value.

### TECHNICAL FIELD

The present disclosure relates to the field of wireless communication and more particularly relates to the method and system for Radio Access Network (RAN) adaptations for simplifying RAN processing.

### BACKGROUND ART

5G mobile communication technologies define broad frequency bands such that high transmission rates and new services are possible, and can be implemented not only in “Sub 6 GHZ” bands such as 3.5 GHz, but also in “Above 6 GHZ” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In recent years, several broadband wireless technologies have been developed for providing better applications and services to meet growing requirements of broadband subscribers. Second Generation (2G) wireless communication system had been developed to provide voice services while ensuring mobility of users. Third Generation (3G) wireless communication system supports not only the voice service but also data service. In recent years, fourth generation wireless communication system has been developed to provide high-speed data service. However, currently, the Fourth Generation (4G) wireless communication system suffers from a lack of resources to meet the growing demand for high-speed data services. This problem is solved by deployment of Fifth Generation (5G) wireless communication system to meet the ever-growing demand for high-speed data services.

Furthermore, 5G wireless communication system provides ultra-reliability and supports low-latency applications. For next generation of wireless communication systems i.e., Sixth Generation (6G) wireless communication system, various technologies have been under consideration. The various technologies may correspond to Visible Light Communication (VLC), Terahertz band (THz) i.e., frequencies from 100 GHz to 3 THz, infrared wave, ultraviolet wave, etc. Among all these technologies, the THz band is envisioned as a potential technology for a diverse range of applications, which exist within nano, micro as well as macro scales. The various features of the THz band are that it may provide Terabits per second (TBPS) data rates, reliable transmission, and minimal latency. Frequencies from 100 GHz to 3 THz are promising bands for the next generation of wireless communication systems because of the wide range of the unused and unexplored spectrum. As per the conventional literature available for THz band communication systems, the frequencies also offer the potential for revolutionary applications in the realm of devices, circuits, software, signal processing, and systems. The ultra-high data rates facilitated by mmWave, and THz wireless local area and cellular networks enable super-fast download speeds for computer communication, autonomous vehicles, robotic controls, information shower, high-definition holographic gaming, entertainment, video conferencing, and high-speed wireless data distribution in data centers. In addition to the extremely high data rates, there are promising applications for future mmWave and THz systems that are likely to evolve in 6G networks, and beyond.

Applications like very high-definition video streaming, Augmented Reality (AR)/Virtual Reality (VR), holography, and digital twin are going to require very stringent KPIs to meet the expected user experience. However, the existing 3^{rd} Generation Partnership Project (3GPP) framework does not support very high throughput, low latency, and zero jitters at the same time.

Since the advent of LTE (4G) and NR (5G), multiple applications have evolved moving towards high usage of channel bandwidth and decreased latency leading to enhanced user experience. This trend is going to further lead to many future applications having very stringent requirements where high throughput, low latency, and zero jitters are going to be of utmost importance and expected to be met at the same time. All these applications like high-definition video streaming, AR, VR, Mixed Reality (MR), Extended Reality (XR), immersive VR, holography, and digital twin require dedicated processing. In a non-limiting example, the future application Key Performance Indicator (KPI) requirement can have very peak throughput upto 10s of Gbps and bounded by sub-1 ms latency.

Particularly, the conventional processing stack follows a hierarchy in terms of the application layer, transport layer, internet protocol, and then the RAN protocol. Further, fine-tuning certain protocol layer functionality might be required to give different services for each and every application. However, this level of fine-tuning protocol procedure is not supported today by 3GPP. Also, protocol hierarchy involves significant processing and latency at each layer. An example of a layered architecture view of protocol stack used in data path is shown in FIG. 1, in accordance with an existing state of art.

Further, New Radio or NR (5G) supports typically three use cases Enhanced Mobile Broadband (cMBB), Ultra-Reliable Low Latency Communication (uRLLC), and Massive Machine Type Communication (mMTC). 3GPP 5G procedures are defined in order to meet the KPI requirements. However, future requirements for new use case applications require much higher throughputs and extremely low latencies. Moreover, the KPIs are expected to be met together and for a variety of users. Existing 3GPP 5G procedures and architecture are expected to fall short of meeting the stringent Quality of Service (QoS) requirements for future applications as the procedures are defined for the pre-defined use cases. The dynamics of the new generation applications and their requirements may not be easily possible to generalize under a specific set of QoS characteristics and will require a more enhanced and flexible framework to handle the data flow. Therefore, there is a need to reconsider designing some procedures which are more flexible and suitable to meet the expectations for future communication networks.

Taking into account a scenario where multiple IPs are mapped to a single Data Radio Bearer (DRB), which leads to handling multiple applications with a single kind of priority. For example, all IP flows are handled over a single internet Packet Data Unit (PDU) session mapped to a single DRB in a typical 5G service. However, for example, streaming applications, like Video streaming, Over-The-Top (OTT) platforms, and similar online streaming applications will require a different configuration as compared to a banking application on an end-user device. Since both packets will likely be served in the single DRB, further segregation of procedures within the DRB is not possible as per the conventional technique. Thus, all packets within one DRB experience will receive similar treatment. An example block diagram depicting mapping of multiple IPs into a single DRB is shown in FIG. 2, in accordance with an existing state of the art.

Hence, handling individual IP flow is not possible in current procedures as RAN operates at the DRB level. Thus, there is a need for better control by providing IP level differentiation for finer processing. Also, since RAN operates at the DRB level, it is not possible to customize a procedure for some specific Applications. All packets under the same DRB experience the same treatment although the requirement of that IP flow may be completely different. An example structure of protocol layer 2 is shown in FIG. 3, in accordance with the existing state of the art, in which a request from the user equipment (UE) is processed at the protocol layer 2 of the RAN.

Multiple applications used by a user are handled using different IP flows which are mapped either to a set of QoS flow IDs or further subsequently mapped to different DRBs at RAN. All the RAN procedures are defined per DRB level. Hence, different applications experience similar handling if they are mapped to the single DRB. There is no separation in prioritizing certain applications within the single DRB. Typically, even today, most of the applications used by mobile users are mapped to the single DRB that manages the entire traffic for the internet PDU session. As an example, only for voice and video calling a separate IP Multimedia Subsystem (IMS PDU) session is established as it is known that voice and video require special handling of the data. No differentiation within the apps is possible unless and until some proprietary solutions are made available.

Therefore, each application flow mapped to the single DRB undergoes similar steps of operations as per the protocol hierarchy and there is no inter-flow differentiation if they belong to the same DRB. In NR, packets from different applications can be mapped to the same DRB or different DRBs. Each layer additionally receives what is called a Service Data Unit (SDU) and then puts a header to form a Protocol Data Unit (PDU). Each PDU consists of a layer header followed by the SDU. Also, Medium Access Control (MAC) layer concatenates multiple data packets and transfers the packets over the air in the form of transport blocks based on grants (i.e., an amount of data that can be transmitted over the air). Radio Link Control (RLC) protocol performs segmentation when grants are not sufficient. The segmentation is a process in the RLC layer protocol where large data packets are divided into smaller segments for efficient transmission over the network. Therefore, each layer involves significant processing in terms of header processing. An example depicting multiple application flows mapped to the single DRB that undergoes different layers as per the protocol hierarchy is shown in FIG. 4, in accordance with the existing state of the art.

Some amount of differentiation can be made if the packets are mapped to different DRBs, but the NR can support at max 32 DRBs, but the number of applications in the future requiring different handling can be very large. With the expected increase in the diverse use cases for next-generation communication technology, differentiation may be required to handle individual IP flows for each application. The differentiation is expected to be a necessary step to help diversify the use case experiences for the end user. Hence, managing different procedures within the DRB is going to be helpful to increase flexibility in adapting to newer use cases and still have a flexible and dynamic procedure to attend to those use cases.

Taking into account another scenario where any change of configuration of RAN has to happen through a control panel. The control plane provides the RAN parameters impacting the configuration of RLC, Packet Data Convergence Protocol (PDCP), MAC layer, and physical (PHY) layer that is configured by the control plane of a Radio Resource Control (RRC) module for protocol stack management and operation.

Most of the control plane decisions are taken by the RRC module at the RAN and an Access and Mobility Management Function (AMF) module at the Core Network. RAN procedures like concatenation at the MAC layer in 5G and segmentation at RLC in 5G are driven by the circumstances under which modem protocol is operating. Further, these procedures are completely unaware of what kind of application data is being handled. The configurations like RLC Sequence Number (SN) range, window size, t-Reassembly timer, t-StatusProhibit timer, t-pollRetransmit timer, etc., and similar configurations like Packet Data Convergence Protocol Sequence Number (PDCP SN), PDCP discard timer, etc. are all statically configured and can be changed by RRC module through a modification message. As per current state of the art, it is difficult for all the configurations control to predict how much time the RAN shall wait under different scenarios of operations. The control plane operates independently that of a user plane and is typically slow in processing, although user plane is dependent on control plane for all the configuration. A change in the configuration by the control plane is not reflected immediately and is time-consuming. Further, dynamically changing configuration with immediate impact is not possible. An example of a control plane protocol stack is shown in FIG. 5a, in accordance with the existing state of the art.

However, when channel conditions are good, the RAN processing is almost deter-ministic in a manner such that because of fewer losses, almost all packets are received making the processing as such redundant. This can be harnessed to make simpli-fication. PDCP SN and RLC SN, both are almost providing the same information except for a few scenarios like split bearer and dual connectivity. Further, when channel conditions are good, the UE typically receives a large number of grants so that the UE can transfer a high amount of data and make maximum use of the available transmission opportunity. Furthermore, when UE receives the grant, the UE ac-cumulates the currently available packets to be transferred. If some of the grants are remaining and if a complete packet cannot be adjusted, then RLC segments the packets as shown in FIG. 5b, in accordance with the existing art. Thus, FIG. 5B illustrates a flow diagram depicting an example of a packet segmentation process.

Further, segmentation involves an extra process of RLC header preparation and an extra process of reassembling the packet at the receiver end. Moreover, under good channel conditions, when packet losses are almost negligible, the status report (sending feedback about packet reception) is almost redundant as most likely, all packets would be ACKed, i.e., acknowledged.

Therefore, for static RAN procedures, RAN procedures and parameters are pre-defined i.e., static and not dynamic in nature. Thus, the RAN procedures do not adapt well to the application behaviour and impact of channel fluctuations on the application layer. Faster processing is beneficial and possibly to be achieved under good channel conditions, but the fixed set of procedures and the protocol hierarchy can be a limiting factor for the same. Multiple protocol layers, such as application, transport, internet, and RAN involve some significant processing and introduce delays, as protocol hierarchy involves some end-to-end redundant processing. RAN operates at the DRB level, where the IP flow awareness is not possible to be handled to customize a procedure for some specific applications. All packets under this DRB experience the same treatment although the requirement of that IP flow may be completely different.

Additionally, change in RAN configuration is also static in nature. Any configuration change at RAN happens through means of a centralized unit, i.e., the control plane, and is typically, time-consuming. The RAN configurations are changed due to various op-crational reasons like mobility, or operator-initiated changes but the configurations are managed centrally via the control plane. Moreover, the changes are not very frequent. Further, no control plane procedure exists for dynamically changing the configuration in a faster way. Control plane changes are limited to configuration changes. However, fine-tuning the functionalities for RAN processing can further enhance user experience. Thus, dynamic change of configuration is not possible to be supported in RAN configuration as per conventional methods and techniques.

Additionally, under very good channel conditions, acknowledgment procedure can be an overhead as status report information contains all ACKs. When the channel is good, grants are high, and some processing overhead is involved in segmenting the packet. A lot of redundancies can be removed when channel conditions are very good.

Therefore, the current existing 3GPP framework does not allow dynamic adaption of RAN and the transport layer procedure to meet the application requirements. Further, the transport layer is agnostic to the RAN procedures and events. Therefore, there needs a lot more cross-layer synergy in order to improve the user experience.

Therefore, in view of the above-mentioned problem scenarios, there lies a need to provide improved designing procedures which are more flexible and suitable to meet the expectations for future networks and future applications.

### DISCLOSURE OF INVENTION

### Technical Problem

This summary is provided to introduce a selection of concepts, in a simplified format, that are further described in the detailed description of the invention. This summary is neither intended to identify key or essential inventive concepts of the invention nor is it intended for determining the scope of the invention.

The present disclosure provides a method and device for dynamically modifying radio access network (RAN) configuration by a communication device in wireless communication system.

### Solution to Problem

According to an embodiment, the present disclosure relates to a method for dynamically modifying Radio Access Network (RAN) configuration at a user plane during a RAN layer processing by a communication device in wireless communication system. The method comprises determining a data packet loss ratio during a transmission of a plurality of data packets via a transmission channel at a periodic time interval. The method further comprises comparing the determined data packet loss ratio with a first threshold value to determine good channel conditions. The method furthermore comprises determining, based on a result of comparison, whether a current condition of the transmission channel is reliable or unreliable for the transmission of the plurality of data packets. Upon a determination that the current condition of the transmission channel is reliable, the method comprises incrementing a timestamp corresponding to a time at which the current condition of the transmission channel is determined as reliable. Subsequently, the method comprises dynamically modifying the RAN configuration at the user plane upon a determination that the incremented timestamp value is greater than the second threshold value.

According to another embodiment, the present disclosure relates to a communication device for dynamically modifying Radio Access Network (RAN) configuration at a user plane during a RAN layer processing. The communication device comprises one or more processors and a memory communicatively coupled with the one or more processors. The one or more processors are configured to determine a data packet loss ratio during a transmission of a plurality of data packets via a transmission channel at a periodic time interval. Further, the one or more processors are configured to compare the determined data packet loss ratio with a first threshold value. The one or more processors are further configured to determine, based on a result of the comparison, whether a current condition of the transmission channel is reliable or unreliable for the transmission of the plurality of data packets. Upon a determination that the current condition of the transmission channel is reliable, the one or more processors are configured to increment timestamp corresponding to a time at which the current condition of the transmission channel is determined as reliable. Furthermore, the one or more processors are configured to determine whether the incremented timestamp value is greater than a second threshold value. Subsequently, the one or more processors are configured to dynamically modify the RAN configuration at the user plane upon a determination that the incremented timestamp value is greater than the second threshold value.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates an example block diagram of a layered architecture view of a protocol stack used in data path, in accordance with an existing state of the art;

FIG. 2 illustrates an example block diagram depicting mapping of multiple IPs into a single DRB, in accordance with an existing state of the art;

FIG. 3 illustrates an example structure of protocol layer 2 depicting a processing flow of a user equipment (UE) request received at the protocol layer 2 of the RAN, in accordance with an existing state of the art;

FIG. 4 illustrates an example diagram depicting multiple application flows mapped to a single DRB undergoing different layers as per protocol hierarchy defined in 3GPP, in accordance with an existing state of the art;

FIG. 5a illustrates an example block diagram of a control plane protocol stack, in accordance with an existing state of the art

FIG. 5b illustrates a flow diagram depicting an example of a packet segmentation process, in accordance with an existing state of the art;

FIG. 6 illustrates a schematic block diagram of a communication system for dynamically modifying Radio Access Network (RAN) configuration, in accordance with an embodiment of the present disclosure;

FIG. 7 illustrates a flow chart of method steps for dynamically modifying RAN configuration at the user plane during a RAN layer processing, in accordance with an embodiment of this disclosure;

FIG. 8 illustrates a flow chart of method sub-steps of the method step 718 of FIG. 7, in accordance with an embodiment of the present disclosure;

FIG. 9 illustrates a line diagram of a series of method steps for changing RLC procedures at a receiver side, in accordance with an embodiment of the present disclosure;

FIG. 10 illustrates a line diagram of a series of steps for changing RLC procedures at a transmitter side, in accordance with an embodiment of the present disclosure; and

FIGS. 11a and 11b illustrate an exemplary embodiment of a MAC-Control Elements (MAC-CE) details for the dynamic RAN handling, in accordance with an embodiment of the present disclosure.

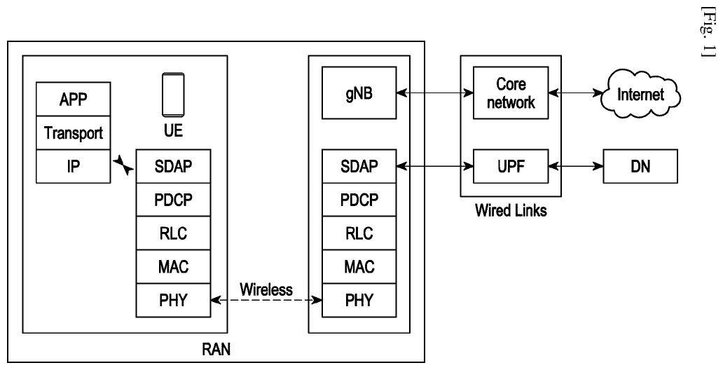

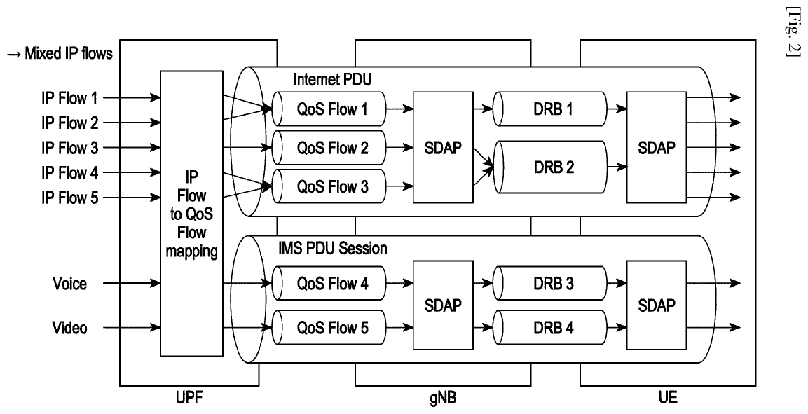

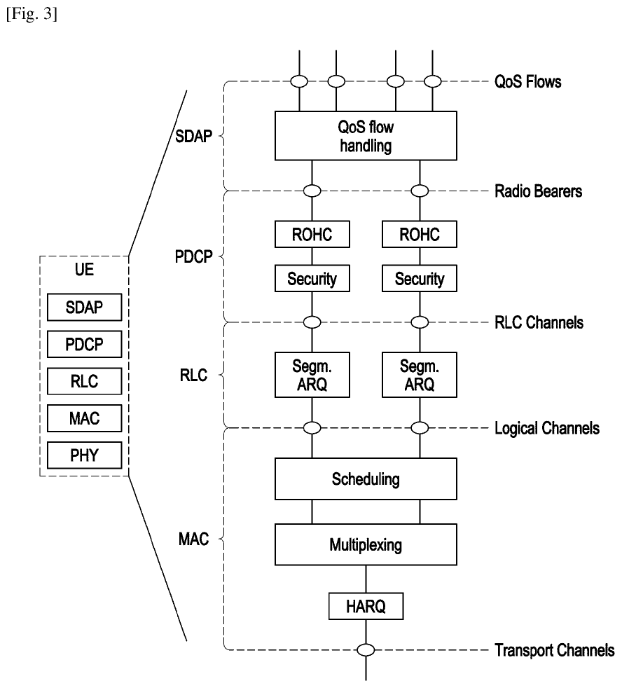

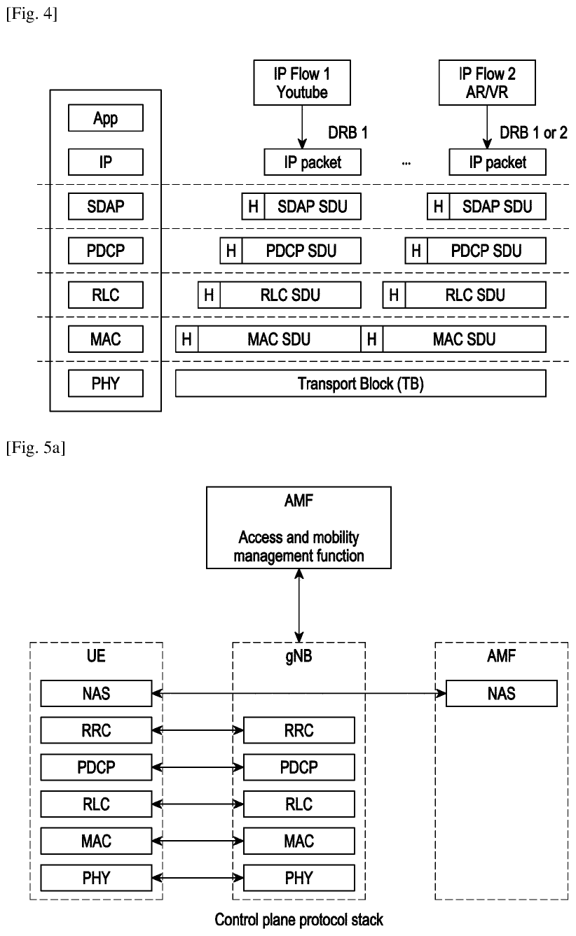

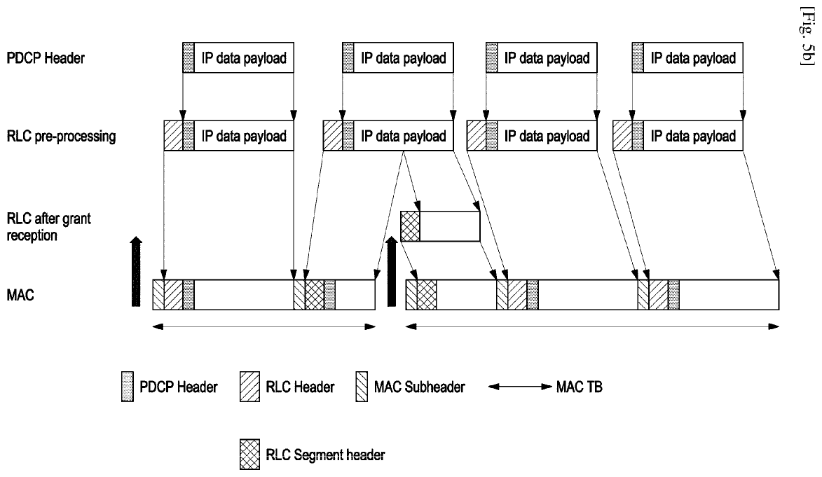

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been rep-resented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### MODE FOR THE INVENTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

The term “some” or “one or more” as used herein is defined as “one”, “more than one”, or “all.” Accordingly, the terms “more than one,” “one or more” or “all” would all fall under the definition of “some” or “one or more”. The term “an embodiment”, “another embodiment”, “some embodiments”, or “in one or more embodiments” may refer to one embodiment or several embodiments, or all embodiments. Accordingly, the term “some embodiments” is defined as meaning “one embodiment, or more than one embodiment, or all embodiments”.

The terminology and structure employed herein are for describing, teaching, and illu-minating some embodiments and their specific features and elements and do not limit, restrict, or reduce the spirit and scope of the claims or their equivalents. The phrase “exemplary” may refer to an example.

More specifically, any terms used herein such as but not limited to “includes,” “comprises,” “has,” “have” and grammatical variants thereof do not specify an exact limitation or restriction and certainly do not exclude the possible addition of one or more features or elements, unless otherwise stated, and must not be taken to exclude the possible removal of one or more of the listed features and elements, unless otherwise stated with the limiting language “mush comprise” or “needs to include”.

Whether or not a certain feature or element was limited to being used only once, either way, it may still be referred to as “one or more features”, “one or more elements”, “at least one feature”, or “at least one element.” Furthermore, the use of the terms “one or more” or “at least one” feature or element does not preclude there being none of that feature or element unless otherwise specified by limiting language such as “there needs to be one or more” or “one or more element is required.”

As used herein, each of such phrases as “A or B”, “at least one of A and B”, “at least one of A or B”, “A, B, or C”, “at least one of A, B, and C” and “at least one of A, B, or C” may include all possible combinations of the items enumerated together in a corresponding one of the phrases. As used herein, such terms as “1st” and “2nd” or “first” and “second” may be used to simply distinguish a corresponding component from another, and does not limit the components in other aspect (e.g., importance or order).

Unless otherwise defined, all terms, and especially any technical and/or scientific terms, used herein may be taken to have the same meaning as commonly understood by one having ordinary skill in the art.

Embodiments of the present disclosure will be described below in detail with reference to the accompanying drawings.

It is to be noted that the term “transmitter”, and “transmitting system/device” may be used interchangeably throughout the description of the present disclosure. Also, the term “receiver”, and “receiving system/device” may be used interchangeably throughout the description of the present disclosure.

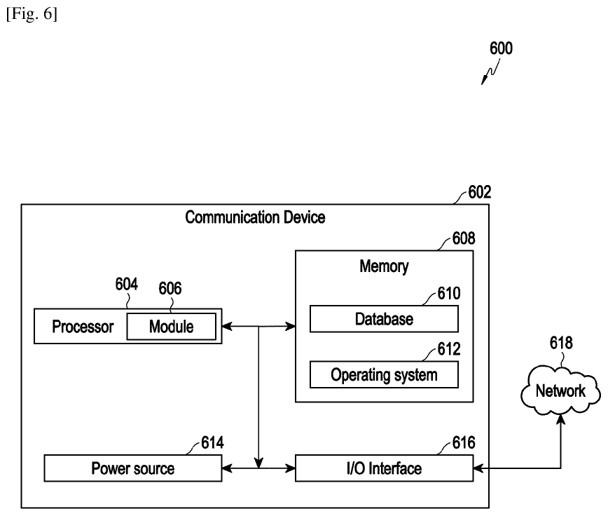

FIG. 6 illustrates a schematic block diagram of a communication system 600 for dynamically modifying Radio Access Network (RAN) configuration, in accordance with an embodiment of the present disclosure. The communication system 600 includes a communication device 602 communicating via a network 618 with one or more communicating devices 602. The communication device 602 includes a processor(s) 604 (hereinafter also referred to as “one or more processors”) which includes module(s) 606 (hereinafter also referred to as “one or more modules”), a memory 608, a power source 614, and an Input/Output (I/O) interface 616. The memory 608 includes a database 610 and an operating system (OS) 612. The processor 604, the memory 608, the power source 614, and the I/O interface 616 are communicatively coupled with each other. In one or more embodiments, the communication system 600 corresponds to one of a transmitting system/device or a receiving system/device. The transmitting system/device may include a transmitter (i.e., the communication device 602) for transmitting network packets through the network 618. Alternatively, the receiving system/device may include a receiver (i.e., the communication device 602) for receiving the transmitted network packets through the network 618. In a non-limiting example, the transmitter may correspond to a base station or a cell site or a cellular tower, etc. Further, the receiver may correspond to a user equipment (UE), a smartphone, a mobile, a tablet, a computer, a laptop, etc (hereinafter, a UE). Additionally, the communication device 602 corresponding to the base station or the UE may be implemented as a device including a processor 604 and a transceiver (not depicted) for transmitting and receiving signals in the network 618.

In one or more embodiments, the processor 604 may be operatively coupled to the module 606 for processing, executing, or performing a set of operations for dynamically modifying the RAN configuration. In one or more embodiments, the processor 604 may execute processes in a virtual storage area network. The processor 604 may include specialized processing units such as integrated system (bus) con-trollers, memory management control units, floating point units, graphics processing units, digital signal processing units, etc. In one or more embodiments, the processor 604 may include a central processing unit (CPU), a graphics processing unit (GPU), or both. The processor 604 may be one or more general processors, digital signal processors, application-specific integrated circuits, field-programmable gate arrays, servers, networks, digital circuits, analog circuits, combinations thereof, or other now-known or later developed devices for analyzing and processing data. The processor 604 may execute one or more instructions, such as code generated manually (i.e., programmed) to perform one or more operations disclosed herein throughout the present disclosure.

In one or more embodiments, the processor 604 comprises the module 606 for performing specific operations. The term “module” or “modules” used herein may imply a unit including, for example, one of hardware, software, and firmware or a combination of two or more of them. The “module” may be interchangeably used with a term such as logic, a logical block, a component, and the like. The “module” may be a minimum device component for performing one or more functions or maybe a part thereof. The processor 604 may control the module 606 to execute a specific set of op-crations described in the disclosure.

In one or more embodiments, the memory 608 may include any non-transitory computer-readable medium known in the art including, for example, volatile memory, such as Static Random-Access Memory (SRAM) and Dynamic Random-Access Memory (DRAM), and/or non-volatile memory, such as Read-Only Memory (ROM), Erasable Programmable ROM, flash memories, hard disks, optical disks, and magnetic tapes. The memory 608 is communicatively coupled with the processor 604 to store bitstreams or processing instructions for completing the process. Further, the memory 608 may include the OS 612 for performing one or more tasks of the communication device 602, as performed by a generic operating system in the communications domain or the standalone device. In one or more embodiments, the database 610 may be configured to store the information as required by the module 606 and the processor 604 to perform one or more functions for dynamically modifying RAN configuration in a user plane during a RAN layer processing, as discussed herein throughout the present disclosure. Further, the memory 608 may store one or more threshold values for performing the operations, as discussed throughout the disclosure.

In one or more embodiments, the power source 614 may relate to a source from which necessary power is supplied to the communication device 602 for performing one or more operations. The power source 614 may vary depending on the type of the communication device 602, but common power sources include batteries, rechargeable batteries, direct current (DC) power supply, alternating current (AC) power supply, or a combination thereof. The power source 614 is essential for the communication device 602 to function properly and can determine factors such as portability, runtime, and charging requirements.

In one or more embodiments, the I/O interface 616 refers to hardware or software components that enable data communication between the communication device 602 and any other devices or systems. The I/O interface 616 serves as a communication medium for exchanging information, commands, or data with the other devices or systems via the network 618. Further, one or more instructions executable by the processor 604 may be transmitted or received over the network 618 via the I/O interface 616. The I/O interface 616 may be a part of the processor 604 or maybe a separate component. The I/O interface 616 may be created in software or maybe a physical connection in hardware. The I/O interface 616 may be configured to connect with the network 618, external media, a display unit, or any other components in the communication system 600. The connection with the network 618 may be a physical connection, such as a wired Ethernet connection, or may be established wirelessly. Likewise, the additional connections with other components of the communication system 600 may be physical or may be established wirelessly.

In one or more embodiments, the network 618 may include wired networks, wireless networks, Ethernet Audio Video Bridging (AVB) networks, or combinations thereof. The wireless network may be a cellular telephone network, an 802.11, 802.16, 802.20, 802.1Q, or WiMax network. Further, the network 1016 may be a public network, such as the Internet, a private network, such as an intranet, or combinations thereof, and may utilize a variety of networking protocols now available or later developed including, but not limited to TCP/IP-based networking protocols. The communication system 600 is not limited to operation with any particular standards and protocols. As an exemplary embodiment, standards for Internet and other packet-switched network transmissions (e.g., TCP/IP, UDP/IP, HTML, and HTTP) may be used.

In one or more embodiments, the processor 604 is configured to dynamically modify RAN configuration utilizing the module 606. Further, the module 606 may include one or more sub-modules to perform operations disclosed throughout the disclosure.

In one or more embodiments, the processor 604 is configured to determine a data packet loss ratio during a transmission of a plurality of data packets via a transmission channel at a periodic time interval. The data packet loss ratio during transmission refers to a percentage of data packets that fail to reach an intended destination. The data packet loss ratio is a measure of the reliability and efficiency of the wireless network. The data packet loss ratio can be caused by various factors, such as interference, signal attenuation, congestion, errors in transmission, etc. More data packet loss ratio refers to an interrupted connection. On the contrary, less data packet loss ratio ensures smooth and uninterrupted delivery of data in wireless networks. Further, the transmission channel refers to a medium through which data is transferred between the communication device 602 and the network 618. The transmission channel can be wireless, such as radio waves or infrared signals, etc. In an alternate embodiment, the transmission channel may correspond to a physical channel, such as a copper wire or fiber optic cable, or the like. The periodic interval may correspond to a certain time period within which the data packet loss ratio can be determined. In a non-limiting example, the processor 604 is configured to determine the data packet loss ratio for the time period of 100 milliseconds (ms). During the 100 ms time period, the data packet loss ratio is 2%. The data packet loss of 2% corresponds to out of every 100 data packets, only 2 data packets are lost.

In one or more embodiments, the processor 604 is configured to compare the determined data packet loss ratio with a first threshold value stored in the memory 608 to determine good channel conditions. The good channel conditions in network communication refer to a scenario where the data packet loss ratio is minimal or negligible. In such conditions, the network can achieve higher data throughput and ensure the accuracy and reliability of the transmitted data. The first threshold value is determined based on one of a heuristic-based learning model and values associated with a channel quality estimation obtained from one or more lower layers. The heuristic-based learning model uses heuristics or rules of thumb to guide the learning process. Instead of relying purely on data in a current condition, the heuristic-based learning model in-corporates prior conditions to make decisions to determine the first threshold value. Further, the first threshold value is determined or configured based on one or more lower layers data relating to channel quality estimation based on transmission or receiving data packets. Any heuristic-based learning model or a configuration can set this first threshold value. In a non-limiting example, the first threshold value may correspond to 5%. In continuation with the example illustrated in the previous step, the data packet loss ratio of 2% is less than the first threshold value of 5%. Thus, during the periodic time interval of 100 milliseconds, as an example, the transmission channel is considered to be in good channel condition.

In one or more embodiments, based on a result of the comparison, the processor 604 is further configured to determine whether a current condition of the transmission channel is reliable or unreliable for the transmission of the plurality of data packets. The transmission channel is reliable when it may be ensured that data is transmitted ac-curately and in a timely manner. Thus, the reliability of the transmission channel ensures that the data reaches the recipient without any loss or corruption. On the contrary, the transmission channel is unreliable when the transmission channel is prone to errors and may result in data loss or corruption. If the result of the comparison relates to the data packet loss ratio that is more than the first threshold value, then the processor 604 is configured to determine whether the transmission channel is more prone to error. Further, if the data packet loss ratio is more than the first threshold value, the processor 604 is configured to fallback to default configuration to RAN. Furthermore, if the data packet loss ratio is less than the first threshold value, the processor 604 is configured to determine if the channel is reliable.

In one or more embodiments, upon a determination that the current condition of the transmission channel is reliable, the processor 604 is configured to increment a timestamp corresponding to a time at which the current condition of the transmission channel is determined as reliable. The timestamp is incremented to determine a timeline of the reliability of the transmission channel. The more reliable timeline signifies a very reliable channel condition, and there is a very less number of packet loss in the transmission channel. In a non-limiting example, if the channel condition is determined as reliable at timestamp X, then the processor 604 is configured to increment the timestamp by 10 ms from the timestamp X to determine an extent of the reliable transmission channel. Similarly, if the channel condition is still reliable, the processor 604 is configured to again increment the timestamp by 10 ms. So, the incremented timestamp value is (10+10) ms=20 ms.

In one or more embodiments, the processor 604 is configured to determine whether the incremented timestamp value is greater than a second threshold value stored in the memory 608 to determine consistently good channel conditions. Upon incrementing the timestamp, the processor 604 is configured to compare the incremented timestamp value with a second threshold value. If the incremented timestamp value is greater than the second threshold value, then the channel conditions are considered consistently good. Similar to the first threshold value, the second threshold value is also determined based on the heuristic-based learning model and values associated with the channel quality estimation obtained from one or more lower layers. In a non-limiting example, the second threshold value may be considered as 35 ms. Thus, if the incremented timestamp value is greater than 35 ms, then the processor 604 is further configured to determine the consistently good channel conditions.

In one or more embodiments, the processor 604 is configured to dynamically modify the RAN configuration at the user plane upon a determination that the incremented timestamp value is greater than the second threshold value. Thus, if the channel conditions are consistently good, the processor 604 is configured to dynamically modify the configuration at the user plane without requesting a control plane to modify the RAN configuration. To modify the RAN configuration, the processor 604 is configured to transmit, via a Medium Access Control-Control Element (MAC-CE), a control signal from a transmitting system/device to a receiving system/device indicative of a request or notification for applying a specific RAN configuration. The MAC-CE is a form of communication between the transmitting system/device and the receiving system/device. In a non-limiting example, the processor 604 of the transmitting system 600 may transmit the MAC-CE for configuration change in the RAN layer if the channel conditions are consistently good.

In one or more embodiments, for dynamically modifying the RAN configuration, the processor 604 is further configured to transmit a control signal from the transmitting system/device to the receiving system/device indicative of a request or notification for applying the specific RAN configuration. The transmission of control signals is performed via the MAC-CE. The MAC-CE is a signal message to share the information which is important for the operation and synchronization between the transmitting system/device and the receiving system/device. The MAC-CE transmits one or more configurations for synchronization between the transmitting system/device and the receiving system/device. Further, the synchronizing between the transmitting system/device and the receiving system/device is based on a specific Quality of Service (QoS) that is required by one or more applications running on the transmitting system/device. In another embodiment, an Artificial Intelligence (AI) module can also be used to take this decision dynamically. The AI can further also help in allowing or detecting if the channel is secure and can disable security for the packet.

In one or more embodiments, the modification of the RAN configuration comprises at least one of enabling or disabling a segmentation process, enabling or disabling a concatenation process, changing configuration parameters related to the timers and counts, or enabling or disabling a security measurement process, enabling or disabling a recovery process, decreasing or increasing a frequency of transmission of a status report, or modifying a size of at least one of a transmission (Tx) window or a receiving (Rx) window. In an exemplary embodiment, the segmentation process is considered to be utilizing heavy computing resources. Thus, disabling the segmentation process saves computing resources and improves the latency of packet transmission as segmentation involves more processing at both transmitter and receiver. Similarly, modifying the RAN configuration at the user plane level according to the QoS requirements renders a dynamic change of configuration without requesting the control plane. Further, the dynamic change of configuration in the RAN improves user sat-isfaction as the configurations are changed dynamically according to the QoS requirements. Also, enabling or disabling the concatenation feature can reduce RAN overhead and saves computing resources. Furthermore, features of decreasing the frequency of status reports may reduce processing overhead and saves computing resources. Additionally, the size of at least one of the Tx window or the Rx window may tune dynamically, i.e., shouldn't be of static size. The dynamic changes of the Tx window or Rx window in the RLC or PDCP layer may reduce processing overhead and saves computing resources.

In one or more embodiments, the modification of the RAN configuration further comprises reducing PDCP header information and RLC header information by converging the PDCP header information and the RLC header information into a single header information with a single sequence number. Incorporating the header information and including sequence numbers increase computing and processing resources. Thus, if the channel conditions are consistently good, then the processor 604 can be configured to disable the header information in the RLC layer and transmit a dummy header information to bypass header processing in the RLC layer. Therefore, only the single sequence number and header information in the PDCP layer are considered for reassembling data packets in the receiving system/device. Thus, in this way, the above-disclosed procedure helps in saving computing resources by bypassing the incorporation of the header information in the RLC layer.

In one or more embodiments, the modification of the RAN configuration further comprises modifying a congestion control protocol, a flow control protocol, or a Round Trip Time (RTT) estimation protocol at least one of a transport layer or an application layer. Furthermore, the modification of the RAN configuration comprises modifying a data packet size associated with one or more applications corresponding to the application layer. Also, the modification of the RAN configuration comprises enabling or disabling a security profile associated with the one or more applications based on the modification of the at least one of the transport layer or the application layer.

In one or more embodiments, the RAN configuration includes a plurality of RAN parameters. The plurality of RAN parameters includes parameters corresponding to t-Reassembly, t-StatusProhibit, t-Reordering, pollBytes, t-PollRetransmit, and Logical Channel Prioritization (LCP). In a non-limiting example, the t-Reassembly parameter in the RAN determines the reassembly time of the RLC (Radio Link Control) protocol. The t-Reassembly parameter determines how long the network waits for missing RLC SDUs (Service Data Units) before initiating reassembly. In another non-limiting example, the t-StatusProhibit parameter allows operators to prevent sending Status Reports to be sent from the Receiver entity to the Transmitter entity. By prohibiting Status report transmission when channel conditions are really good, operators can optimize network performance. Therefore, by controlling the plurality of RAN parameters, the processor 604 is configured to dynamically modify the RAN configurations. To avoid configuration handshakes for dynamic parameters, the RAN parameters can be driven by rate-adaptive MAC-Control Elements (MAC-CEs) to be applied at the receiver end. The transmitter can adapt to its rate-adaptive receiver characteristics considering channel reciprocity. In cases, where the transmitter needs to be aware of the receiver's applied parameters, Control Packets either at MAC or RLC can be exchanged.

In one or more embodiments, the processor 604 is configured to dynamically modify the RAN configuration based on one or an Artificial Intelligence (AI) based learning model, or a Machine Learning (ML) model stored in the memory 608. For dynamically modifying the RAN configuration, the AI model or the ML model learns patterns and makes predictions based on a given set of data. The AI model or the ML model is trained using historical data to determine optimal configurations for different scenarios as mentioned above. The training may be done using techniques such as regression analysis or clustering algorithms, etc. The AI model or the ML model may be used to predict the optimal configurations for new data based on the patterns learned. By using machine learning, the AI model or the ML model may adapt and improve over time, providing more accurate and reliable RAN configuration.

In one or more embodiments, the processor 604 is further configured to set the dynamically modified RAN configuration to a default RAN configuration upon a determination that the current condition of the transmission channel is busy. Thus, when the data packet loss ratio is greater than the first threshold value, then the transmission channel is busy. Upon determining the transmission channel as busy, the processor 604 is configured to dynamically modify the RAN configuration to the default RAN configuration utilizing the user plane of the RAN.

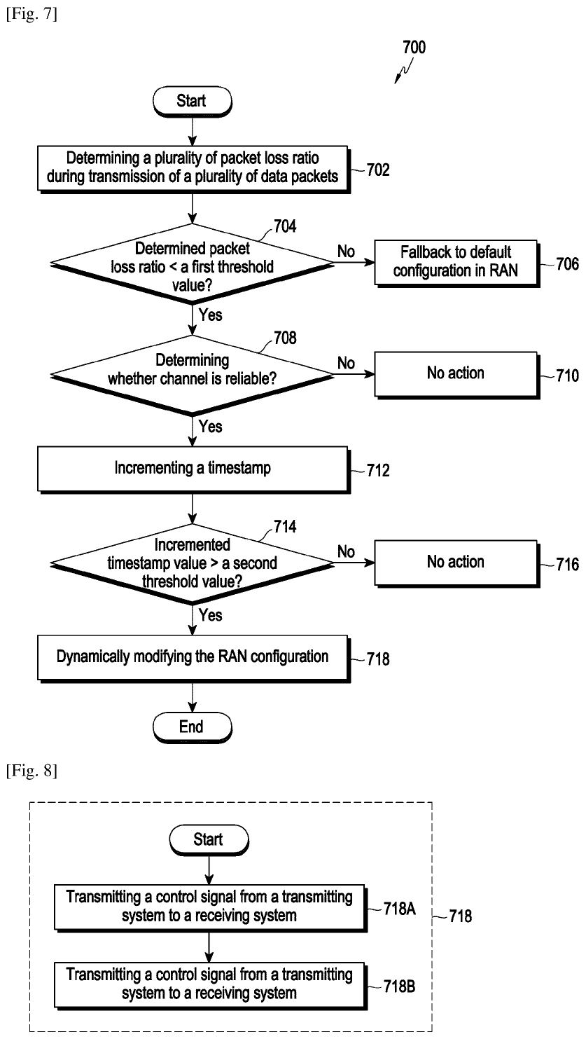

FIG. 7 illustrates a flow chart of method steps for dynamically modifying RAN configuration at the user plane during a RAN layer processing, in accordance with an embodiment of this disclosure. FIG. 7 illustrates a method 700 for dynamically modifying RAN configuration using the communication system 600. The method 700 includes a series of method steps 702 through 718. The method 700 initializes execution from the start block as shown in FIG. 7. For example, the method of FIG. 7 may be performed at the communication device 602 of FIG. 6.

At step 702, the method 700 comprises determining the data packet loss ratio during the transmission of the plurality of data packets via the transmission channel at the periodic time interval. In particular, at step 702, the processor 604 determines the data packet loss ratio during transmission via the transmission channel between the communication device 602 and the network 618. The flow of the method now proceeds to step 704.

At step 704, the method 700 comprises comparing the determined data packet loss ratio with the first threshold value to determine good channel conditions. In particular, the processor 604 compares the determined data packet loss ratio with the first threshold value. If the data packet loss ratio is less than the first threshold value, the flow of the method proceeds to step 708. Alternatively, if the data packet loss ratio is greater than the first threshold value, the flow of the method proceeds to step 706.

At step 706, if the data packet loss ratio is greater than the first threshold value, the transmission channel is considered busy. Upon determining the transmission channel as busy, the method 700 falls back to a default configuration at RAN. In a non-limiting example, the default configuration of the RAN typically includes standard settings that are used as a starting point for network deployment, typically at the establishment state. The default configurations aim to provide balanced and optimal performance for the RAN, considering factors such as coverage, capacity, and interference. The method steps 702 through 706 of the method 700 are repeated until the data packet loss ratio becomes less than the first threshold value.

At step 708, upon determining that the data packet loss ratio is less than the first threshold value, then the method 700 determines whether the channel is reliable or unreliable. If the channel is unreliable then the method 700 then (at step 710) no action is performed by the processor 604. If the channel is reliable, then the flow of the method 700 proceeds to step 712.

At step 712, the method 700 comprises incrementing the timestamp corresponding to the time at which the current condition of the transmission channel is determined as reliable. In particular, the processor 604 increments the timestamp to determine how reliable the transmission channel is. Upon continuously incrementing the timestamp, the method 700 proceeds to step 714.

At step 714, the method 700 comprises determining whether the incremented timestamp value is greater than the second threshold value to determine consistently good channel conditions. In particular, the processor 604 determines if incremented timestamp value increases beyond the second threshold value. If (at step 714) it is determined that the incremented timestamp value is beyond the second threshold value, then the transmission channel can be considered as a very good channel condition, and the method 700 proceeds to step 718. However, if (at step 714) it is determined that the incremented timestamp value is less than the second threshold value, then (at step 716) no action is performed by the processor 604.

At step 718, the method 700 comprises dynamically modifying the RAN configuration at the user plane upon the determination that the incremented timestamp value is greater than the second threshold value. Under this scenario, to simplify the RAN processing, a plurality of steps can be enabled by the receiver to ensure faster processing of data, such as:
1. Disable/Enable Segmentation at RLC: Segmentation is considered to be a heavy process as packets are reassembled and reassembly can take time. When segmentation is disabled, processing cycles are saved and can improve the latency for that packet.
2. Increase the Polling parameter such that Status sending is not frequent, e.g., if the channel is good, reduce the overhead of feedback such that no frequent status report is required to be sent if all are ACKed.
3. Send Status Report only if reaching the limit of the TX window such that the window stalling does not take place but the overhead of status is minimal.
4. Change the PDCP and/or RLC entity window lengths: a larger window allows more transfer of data without acknowledging. Increased throughput is possible to support with less overhead when the window size is large.
5. Optionally, the RLC layer may be disabled at the point where the RLC SN docs not have much significance and then windowing can be done purely based on the PDCP SN only. The SN is an additional overhead to be maintained at the time of packet processing. Under no loss scenario and very good channel conditions, the RLC SN can be optionally disabled to save on computing and processing resources and send a dummy RLC PDU Header to bypass RLC processing. When one layer is disabled, the Central Processing Unit (CPU) resources of this layer can be saved leading to power-saving as well as RLC layer constitutes significant portion of the entire Layer 2 processing.

In an exemplary embodiment, the dynamic RAN may be configured for optimal transport layer performance. In this scenario, whenever packet loss is detected at the RLC, notify the event to the transport layer to consider waiting for the RLC procedure to be completed and compensate for the delay in recovery. The following configurations can be performed for optimal transport layer performance, such as fall-back to the default configuration at RLC for polling, reducing the PDCP/RLC window length by a parameter based on the loss ratio, and restoring the RLC SN for the last SN which was ACKed:
1. In case of fall-back to the default configuration at RLC for polling, when the packet loss occurs, the data packet recovery is required to take place when configured for the acknowledged mode (AM). The data packet recovery can be a time-consuming process as the transmission channel condition may be degraded and hence, polling should happen more frequently in order to check whether recovery is correctly happening or not.
2. In the case of reducing the PDCP/RLC window length by a parameter based on the loss ratio, the parameter can be a function of the amount of loss observed and the QoS requirement. For example,
High loss, Low QoS→Window can be reduced to half the current window size; and
Low loss, High QoS→Window can be reduced to a value between .5 to 1 based on the magnitude of loss.
3. For restoring the RLC SN for the last SN which was ACKed: If the RLC layer was disabled before when losses occur, the RLC layer can be restored and start operating from the last SN which was Acknowledged (Ack) allowing for packet recovery to take place for the new losses detected.

Further, all information exchange is done using MAC-CEs to keep the transmitter and the receiver in synchronization with each other. A threshold to be used for all purposes like deciding good channel conditions, and deciding poor channel conditions are to be learned based on heuristics and obtained values of channel quality that are estimated from the lower layer. All these parameters are based on the channel coherence time. All these thresholds can be learned through ML models or AI models.

In another exemplary embodiment, adopting the RAN inferences across higher layers may be performed. RAN dynamism can very well be translated to further optimizing the end-to-end processing by dynamically fine-tuning the parameters and procedures at higher layers like the transport layer and the application layer. The transport layer can adapt to the events and inferences from the RAN layer to finely adapt its congestion control, flow control, or RTT estimation protocols. The inferences at the RAN are helpful to make educated decisions about the transport layer operations. The information between the RAN and the transport layer can be exchanged via proprietary interfaces and information can be shared in the form of an average, ratio, or count based on a parameter. Similarly, the same information about the adaptations at the RAN and the transport layer can be also implied at the application layer. The application layer can also change its packet size, security profile, etc. based on the RAN and the transport layer changes. The changes at each of the layers such as the transport layer or the application layer need not be immediate and need to be aligned with the timing impact of the change on the individual layer's processing. For example, changes that are consistent in the order of hundreds of milliseconds may be better adapted to the transport layer. However, tens of milliseconds of changes can be adapted at the RAN. This brings an optimal point of operation for each layer's performance and also avoids the overhead of information exchange between the different layers of the network stack.

In yet another exemplary embodiment, the dynamic RAN can fall back to the default configuration and window sizes whenever there are some irrecoverable losses detected.

In yet another exemplary embodiment, the RAN layer parameters can also be reflected in the layers above RAN like the Transport layer and Application layer. Thus, fine-tuning all layers dynamically in order to adapt best to the channel fluctuations.

In yet another exemplary embodiment, the transport layer can also tune its parameter in a rate adaptive manner based on RAN layer parameter exchange and RAN layer feedbacks such that the transport layer weighted parameters for procedures like congestion control, flow control, and RTT calculation are also rate-adaptive based on RAN inferences or behavior reported by the RAN.

In yet another exemplary embodiment, the impact of the RAN can be shared as an inference to any of the upper layers like the transport layer, application layer, etc. such that behavior of individual layers is tuned in a best possible way pertaining to the timing impact of the fluctuations at the upper layers.

In yet another exemplary embodiment, multiple layers can be converged into a single thin layer for resource-constrained and power-constrained devices which would require super convergence of end-to-end layers.

FIG. 8 illustrates a flow chart of method sub-steps of the method step 718 of FIG. 7, in accordance with an embodiment of the present disclosure.

At sub-step 718A of the method step 718, the processor 604 transmits the control signal from the transmitting system/device to the receiving system/device via the MAC-CE for applying the RAN configuration. The transmission of the control signal indicates a request or notification for applying the specific RAN configuration. The MAC-CE is the signal message that shares the information required for operation and synchronization between the transmitting system/device and the receiving system/device. The flow of the method sub-steps now proceeds to sub-step 718B.

At sub-step 718B of the method step 718, the processor 604 synchronizes between the transmitting system/device and the receiving system/device. Therefore, the RAN configuration is dynamically configured to meet the specific QoS required by one or more applications.

While the above-discussed steps in FIG. 7 and FIG. 8 are shown and described in a particular sequence, the steps may occur in variations to the sequence in accordance with various embodiments. Further, a detailed description related to the various steps of FIG. 7 and FIG. 8 are already covered in the description related to FIG. 6 and are omitted herein for the sake of brevity.

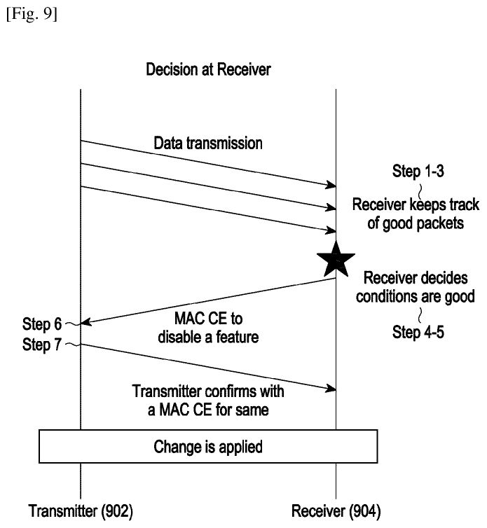

FIG. 9 illustrates a line diagram of a series of steps for changing RLC procedures at a receiver side 904, in accordance with an embodiment of the present disclosure.

As shown in FIG. 9, steps 1-7 relate to the change of RLC procedure in the receiver 904 end. At step 1, the receiver 904 keeps track of all the data transmissions received from the transmitter 902. At step 2, the receiver 902 may understand whether a packet is received correctly or not. Further, at step 3, any packet loss is detected at the receiver 902 as a lost packet. Additionally, at step 4, if the packets received are all well and there is no or very low packet loss ratio, the transmission channel may be considered as good. At step 5, once the transmission channel is considered as good, the receiver 904 may inform based on the various thresholds as per the dynamic RAN op-crations illustrated in FIG. 7. The receiver 904 can inform the transmitter 902 about the required change in the operation to introduce some flexibility and case some of the op-crations like disabling segmentation or increasing the poll parameters to reducing the status report frequency or disable RLC operations for some time. Further, at step 6, the receiver 904 may inform the transmitter 902 to apply a change using the MAC-CE. In a non-limiting example, the information transmitted through the MAC-CE may correspond to disable a feature. Furthermore, at step 7, the transmitter 902 can ac-knowledge the confirmation of the application for the request by responding in another MAC-CE and the configuration change is applied in the RAN layer. In another embodiment, the steps may be applied between the transmitter 902 and the receiver 904 to inform the fallback based on certain characteristics under bad channel conditions.

FIG. 10 illustrates a line diagram of a series of steps for changing RLC procedures at a transmitter side 902, in accordance with an embodiment of the present disclosure.

As shown in FIG. 10, steps 1-7 relate to a change in the procedure for changing RLC procedures at the transmitter 902 end. At step 1, the transmitter receives feedback about the data transmission. Further, at step 2, when there is a failure of data reception, the transmitter 902 understands that appropriate feedback is received, and lost packets are retransmitted. Further, at step 3, based on the feedback received by the transmitter 902, the transmitter 902 may determine the channel conditions. Furthermore, at step 4, when all the data is transmitted, if it is getting continuously acknowledged, and if there are no or very few retransmissions, the transmitter 902 can decide whether the channel is good. In addition, at step 5, the transmitter 902 is configured to decide if the configurations can be changed. Thereafter, at step 6, the transmitter 902 may inform the receiver 904 to apply a certain configuration using the MAC-CE. Finally, at step 7, the receiver 904 accepts by sending another MAC-CE feedback for acknowledging the change in the configuration.

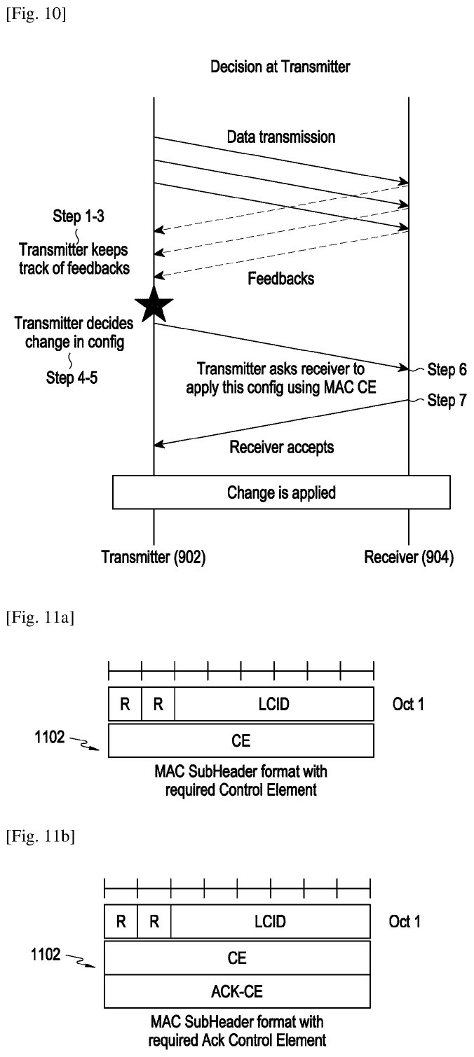

FIGS. 11a and 11b illustrate an exemplary embodiment of the MAC-CE details for the dynamic RAN handling, in accordance with an embodiment of the present disclosure. FIG. 11a relates to a MAC SubHeader format with required Control Element (CE) 1102, and FIG. 11b relates to the MAC SubHeader format with required Ack Control Element (ACK-CE). Generally, the MAC-CE 1102 is at least an 8-bit string of information that can follow the MAC SubHeader. The MAC SubHeader contains a field for LCID (Logical Channel Identifier). The LCID can be assigned which indicates that the CE related to the dynamic RAN configuration handling is to be sent. In a non-limiting example,

$$\begin{matrix}LCID = 40 -> Dynamic RAN configuration request \\ LCID = 41 -> Dynamic RAN configuration request Acknowledgement\end{matrix}$$

The following bit stream as MAC-CE 1102 can inform what is the configuration requested for change. CEs may have multiple interpretations based on a bit of information as interpreted as follows:

In a non-limiting example, different MAC-CE's 1102 bit streams can be understood as follows, which are just an exemplary embodiment of how the bitstream information exchange will take place between the transmitter 902 and the receiver 904:

$$00001111 -> Disable Segmentation$$

$$01010 XX -> Increase Poll Parameters with the reduction in polling parameters by XX \%$$

$$\begin{matrix}11110000 -> Disable RLC processing momentarily \\ 10101010 -> Acknowledge the requested setting and application .\end{matrix}$$

Further, in case of a fall-back to the default configuration or some previous configuration, a special bit stream can be sent in the CE, that is:

$$\begin{matrix}00000001 -> Fall - back to Default configuration . \\ 00000002 -> Fall - back to Previous configuration .\end{matrix}$$

In an exemplary embodiment, the following examples are provided on how to change the configurations dynamically. In an example, a DRB operating at the following configuration, that is, Mode: AM, RLC SN: 18, PDCP SN: 18, t-PollRetransmit: 40 ms, t-StatuProhibit: 35 ms, t-Reassembly: 35 ms, pollPdu: 512, pollByte: 25k. When channel conditions are improved and losses are not seen, either the transmitter 902 or the receiver 904 may trigger based on the thresholds, such as, increase the pollRetransmit by 50% to 60 ms (this parameter of how much to increase can be decided based on QoS configuration, channel strength, etc.). Further, when the channel conditions continue to be good for a further time, the segmentation can be disabled by an exchange of MAC-CE 1102 between the transmitter 902 and the receiver 904, if the receiver 904 is going to take the decision. However, if the transmitter 902 takes the decision, the transmitter 902 can just disable segmentation handling for a downlink (DL) without intimating the receiver 904. Furthermore, if channel conditions are really good for a long time, then, one or more actions may be performed. One or more actions include: (a) the transmitter 902 and the receiver 904 can enter an agreement to disable the RLC layer; (b) the RLC State variables may be stored at the same place where last received packet from the transmitter 902 is received with RLC SN; (c) the RLC State variables are matching at the transmitter 902 and the receiver 904 at this point, and (d) RLC processing can be bypassed when the transmitter 902 chooses to skip RLC layer.

In an example embodiment, the following key performance indicator (KPI) shows how the present disclosure improves processing benefits like saving up the CPU processing, improving latency, and thus allowing a provision to either save power or use the same power to process higher throughput. The transmitter 902 at RLC performs window operations including header preparation and status management operations. Based on measured data from experiments performed on commercially deployed RLC modules, it is observed that status operations take significant cycles on an average per packet required for processing. Any processing also adds to the latency added by that layer in the end-to-end latency of the application. Therefore, reducing the status frequency overall reduces the processing requirement and hence may save CPU cycles. Similarly, if only segmentation is considered, it takes significantly high processing as compared to the complete packet processing on the receiver entity. Hence, disabling segmentation can significantly improve the processing of the latency impact on the end-to-end packet. Further, PDCP and RLC modules constitute almost the same processing involved in each module accounting for a major impact on latency. Disabling RLC, will lead to large improvement in the processing at the modem and impact the latency which in some cases can be as large as upto 50%.

Referring now to the technical abilities and effectiveness of the above-disclosed method 700 and system 600, the present disclosure includes the technical advancement of introducing dynamism at the RAN layer in order to adapt the RAN layer procedures and parameters as rate adaptive. Further, the above-disclosed RAN procedures and parameters in accordance with the method 700 can be adapted based on channel condition behaviour and adapt dynamically to ensure higher performance by simplifying certain procedures. In addition, above disclosed RAN layer inferences scenario helps in making the transport layer aware of the protocol procedures and events, and as a result, the user experience can be enhanced. Similarly, in accordance with the above-disclosed method 700, the application layer can eventually learn about the dynamic adaptations of the lower layers and adapt based on the QoS requirements. Furthermore, in accordance with the above-disclosed method and system/device, multiple redundant functionalities can be removed and still meet the optimal point of operation by fine-tuning control on end-to-end procedures and parameters as disclosed herein. The disclosed method and system/device are beneficial for a power-limited and resource-constrained device. Thus, as per the disclosed method and system/device configuration, the RAN configuration at the user plane can be dynamically changed without requiring any change in the control plane. Thus, quick implementation of the above-disclosed method 700 can easily help in achieving dynamic RAN configuration without requiring any change in the control plane.

As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not necessarily limited to the manner described herein.

Moreover, the actions of any flow diagram need not be implemented in the order shown; nor do all of the acts necessarily need to be performed. Also, those acts that are not dependent on other acts may be performed in parallel with the other acts.

### Abbreviation

The below Table I describes the meaning of the abbreviation used in the disclosure:

TABLE 1

| Abbreviated Form | Full Form |
|---|---|
| ACK | Acknowledgment |
| AM | Acknowledged Mode |
| APP | Application |
| ARQ | Automatic Repeat Request |
| BSR | Buffer Status Report |
| CN | Core Network |
| CQI | Channel Quality Index |
| CRC | Cyclic Redundancy Check |
| DL | Down Link |
| DN | Data Network |
| GBR | Guaranteed Bit Rate |
| gNB | 5G Base Station |
| HARQ | Hybrid ARQ |
| HO | Handover |
| L2 | Layer 2 |
| LCP | Logical Channel Prioritization |
| MAC | Medium Access Control |
| MCS | Modulation Coding Scheme |
| NACK | Negative Acknowledgement |
| NW | Network |
| PDCP | Packet Data Convergence Protocol |
| PDU | Protocol Data Unit |
| PHY | Physical |
| RAN | Radio Access Networks |
| RLC | Radio Link Control |
| RLF | Radio Link Failure |
| RSRP | Reference Signal Received Power |
| RSRQ | Reference Signal Received Quality |
| RTT | Round Trip Time |
| RX | Receiver |
| SDAP | Service Data Adaptation Protocol |
| SDU | Service Data Unit |
| SINR | Signal to Interference and Noise Ratio |
| TCP | Transmission Control Protocol |
| TB | Transport Block |
| TBS | Transport Block Size |
| TP | Throughput |
| TX | Transmitter |
| UE | User Equipment |
| UL | Up Link |
| UM | Unacknowledged Mode |
| UPF | User Plane Function |
| QoS | Quality of Service |
| QFI | QoS Flow Identifier |

1. A method for modifying radio access network (RAN) configuration by a communication device in wireless communication system, the method comprising:
determining a data packet loss ratio during a transmission of a plurality of data packets via a transmission channel at a periodic time interval;
comparing the determined data packet loss ratio with a first threshold value to determine good channel conditions;
determining, based on a result of the comparison, whether a current condition of the transmission channel is reliable or unreliable for the transmission of the plurality of data packets;
incrementing, upon a determination that the current condition of the transmission channel is reliable, a timestamp corresponding to a time at which the current condition of the transmission channel is determined as reliable;
determining whether the incremented timestamp value is greater than a second threshold value to determine consistently good channel conditions; and
dynamically modifying the RAN configuration at a user plane upon a determination that the incremented timestamp value is greater than the second threshold value.

2. The method of claim 1, wherein the dynamically modifying the RAN configuration comprises:
transmitting, via a medium access control-control element (MAC-CE), a control signal from a transmitting device to a receiving device indicative of a request or notification for applying a specific RAN configuration; and
synchronizing between the transmitting device and the receiving device based on a specific quality of service (QoS) that is required by one or more applications running on the transmitting device.

3. The method of claim 1, wherein the modification of the RAN configuration comprises at least one of enabling or disabling a segmentation process, enabling or disabling a concatenation process, changing configuration parameters related to the timers and counts, enabling or disabling a security measurement process, enabling or disabling a recovery process, decreasing or increasing a frequency of transmission of a status report, or modifying a size of at least one of a transmission (Tx) window or a receiving (Rx) window.

4. The method of claim 1, wherein the modification of the RAN configuration further comprises:
reducing packet data convergence protocol (PDCP) header information and radio link control (RLC) header information by converging the PDCP header information and the RLC header information into a single header information with a single sequence number.

5. The method of claim 1, wherein the modification of the RAN configuration further comprises at least one of:
modifying a congestion control protocol, a flow control protocol, or a round trip time (RTT) estimation protocol at least one of a transport layer or an application layer;
modifying a data packet size associated with one or more applications corresponding to the application layer; or
enabling or disabling a security profile associated with the one or more applications based on the modification of the at least one of a transport layer or an application layer.

6. The method of claim 1, wherein the RAN configuration includes at least one RAN parameter, and
wherein the at least one RAN parameter includes at least one parameter corresponding to at least one of t-Reassembly, t-StatusProhibit, t-Reordering, pollBytes, t-PollRetransmit, and logical channel prioritization (LCP).

7. The method of claim 1, further comprising:
setting the dynamically modified RAN configuration to a default RAN configuration upon a determination that the current condition of the transmission channel is unreliable.

8. The method of claim 1, wherein the RAN configuration is dynamically modified based on one of an artificial intelligence (AI) based learning model or a machine learning (ML) model.

9. The method of claim 1, wherein each of the first threshold value and the second threshold value is determined based on one of a heuristic-based learning model and values associated with a channel quality estimation obtained from one or more lower layers.

10. A communication device in wireless communication system, the communication device comprising:
one or more processors; and
a memory communicatively coupled with the one or more processors, wherein the one or more processors are configured to:
determine a data packet loss ratio during a transmission of a plurality of data packets via a transmission channel at a periodic time interval;
compare the determined data packet loss ratio with a first threshold value,
determine, based on a result of the comparison, whether a current condition of the transmission channel is reliable or unreliable for the transmission of the plurality of data packets,
increment, upon a determination that the current condition of the transmission channel is reliable, a timestamp corresponding to a time at which the current condition of the transmission channel is determined as reliable,
determine whether the incremented timestamp value is greater than a second threshold value, and
dynamically modify a radio access network (RAN) configuration at the user plane upon a determination that the incremented timestamp value is greater than the second threshold value.

11. The communication device of claim 10, wherein the communication system corresponds to one of a transmitting device or a receiving device, wherein the transmitting device comprises a transmitter and the receiving device comprises a receiver.

12. The communication device of claim 10, wherein to dynamically modify the RAN configuration, the one or more processors are configured to:
transmit, via a medium access control-control element (MAC-CE), a control signal from a transmitting device to a receiving device indicative of a request or notification for applying a specific RAN configuration, and
synchronize between the transmitting device and the receiving device based on a specific quality of service (QoS) that is required by one or more applications running on the transmitting device.

13. The communication device of claim 10, wherein the one or more processors are further configured to:
set the dynamically modified RAN configuration to a default RAN configuration upon a determination that the current condition of the transmission channel is unreliable.

14. The communication device of claim 10, wherein the modification of the RAN configuration comprises at least one of enabling or disabling a segmentation process, enabling or disabling a concatenation process, changing configuration parameters related to the timers and counts, enabling or disabling a security measurement process, enabling or disabling a recovery process, decreasing or increasing a frequency of transmission of a status report, or modifying a size of at least one of a transmission (Tx) window or a receiving (Rx) window.

15. The communication device of claim 10, wherein the RAN configuration includes at least one RAN parameter, and
wherein the at least one RAN parameter includes at least one parameter corresponding to at least one of t-Reassembly, t-StatusProhibit, t-Reordering, pollBytes, t-PollRetransmit, and logical channel prioritization (LCP).
